(19) United States
(12) Patent Application Publication
(10) Pub. No.: US 2025/0267603 A1
(43) Pub. Date: Aug. 21, 2025

(54) PATTERN FOR SS/PBCH BLOCK

(71) Applicant: Samsung Electronics Co., Ltd., Suwon-si (KR)

(72) Inventor: Hongbo Si, Allen, TX (US)

(21) Appl. No.: 19/047,560

(22) Filed: Feb. 6, 2025

Related U.S. Application Data
(60) Provisional application No. 63/556,178, filed on Feb. 21, 2024.
(60) Provisional application No. 63/730,175, filed on Dec. 10, 2024.

(51) Int. Cl. H04W 56/00; H04L 27/26; H04W 72/0446

(52) U.S. Cl. CPC H04W 56/0015; H04L 27/26025; H04L 27/26035; H04W 72/0446

(57) ABSTRACT

Apparatuses and methods for patterns for synchronization signal block (SSB). A method of a user equipment (UE) in a wireless communication system includes receiving a set of higher layer parameters and identifying, based on the set of higher layer parameters, a set of configurations related to synchronization signals and physical broadcast channel (SS/PBCH) blocks. The set of configurations include a time domain interval between two consecutive SS/PBCH blocks in a burst or an indication of a structure of the SS/PBCH blocks in the burst. The method further includes receiving the SS/PBCH blocks, based on the set of configurations.

### CROSS-REFERENCE TO RELATED AND CLAIM OF PRIORITY

The present application claims priority under 35 U.S.C. § 119(e) to U.S. Provisional Patent Application No. 63/556,178 filed on Feb. 21, 2024, and U.S. Provisional Patent Application No. 63/730,175 filed on Dec. 10, 2024, which are hereby incorporated by reference in their entirety.

### TECHNICAL FIELD

The present disclosure relates generally to wireless communication systems and, more specifically, the present disclosure is related to apparatuses and methods for patterns for a synchronization signal and/or physical broadcast channel (SS/PBCH) block or SSB.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to patterns for an SS/PBCH block or SSB.

In one embodiment, a user equipment (UE) in a wireless communication system is provided. The UE includes a transceiver configured to receive a set of higher layer parameters and a processor operably coupled to the transceiver. The processor is configured to identify, based on the set of higher layer parameters, a set of configurations related to synchronization signals and physical broadcast channel (SS/PBCH) blocks. The set of configurations include a time domain interval between two consecutive SS/PBCH blocks in a burst or an indication of a structure of the SS/PBCH blocks in the burst. The transceiver is further configured to receive the SS/PBCH blocks, based on the set of configurations.

In another embodiment, a base station (BS) in a wireless communication system is provided. The BS includes a processor configured to determine a set of configurations related to SS/PBCH blocks and determine a set of higher layer parameters including the set of configurations. The set of configurations include a time domain interval between two consecutive SS/PBCH blocks in a burst or an indication of a structure of the SS/PBCH blocks in the burst. The BS further includes a transceiver operably coupled to the processor. The transceiver is configured to transmit the set of higher layer parameters and transmit the SS/PBCH blocks based on the set of configurations.

In yet another embodiment, a method of a UE in a wireless communication system is provided. The method includes receiving a set of higher layer parameters and identifying, based on the set of higher layer parameters, a set of configurations related to SS/PBCH blocks. The set of configurations include a time domain interval between two consecutive SS/PBCH blocks in a burst or an indication of a structure of the SS/PBCH blocks in the burst. The method further includes receiving the SS/PBCH blocks, based on the set of configurations.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates a diagram of example on-demand SSB patterns according to embodiments of the present disclosure;

FIG. 6 illustrates a diagram of example on-demand SSB patterns according to embodiments of the present disclosure;

FIG. 7 illustrates a diagram of example on-demand SSB patterns according to embodiments of the present disclosure;

FIG. 8 illustrates a flowchart of an example UE procedure for receiving an on-demand SSB according to embodiments of the present disclosure; and

FIG. 9 illustrates a flowchart of an example method performed by a UE in a wireless communication system according to embodiments of the present disclosure.

### DETAILED DESCRIPTION

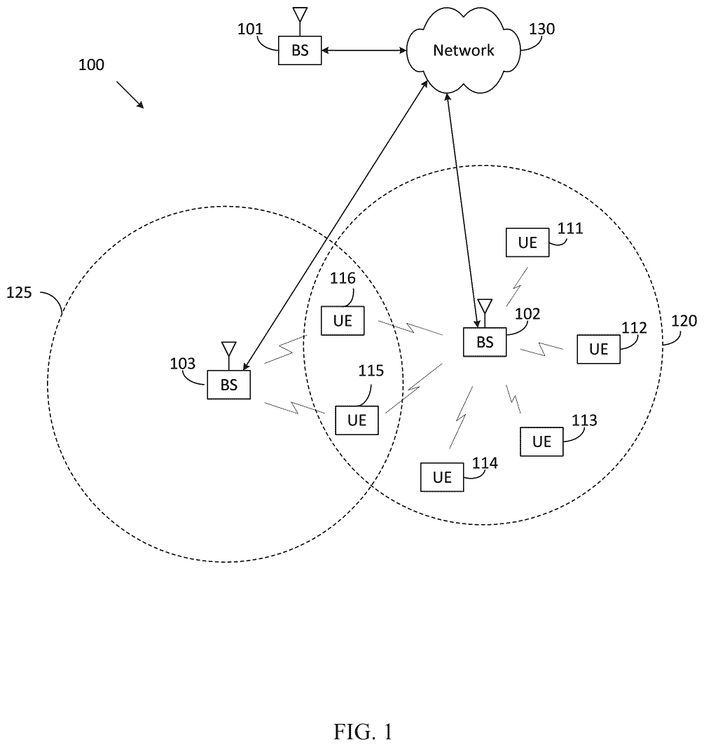

FIGS. 1-8, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.1.0, “NR; Physical channels and modulation;” [2] 3GPP TS 38.212 v17.1.0, “NR; Multiplexing and channel coding;” [3] 3GPP TS 38.213 v17.1.0, “NR; Physical layer procedures for control;” [4] 3GPP TS 38.214 v17.1.0, “NR; Physical layer procedures for data;” and [5] 3GPP TS 38.331 v17.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for using patterns for SSBs. In certain embodiments, one or more of the BSs 101-103 include circuitry, programing, or a combination thereof to support patterns for SSBs.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

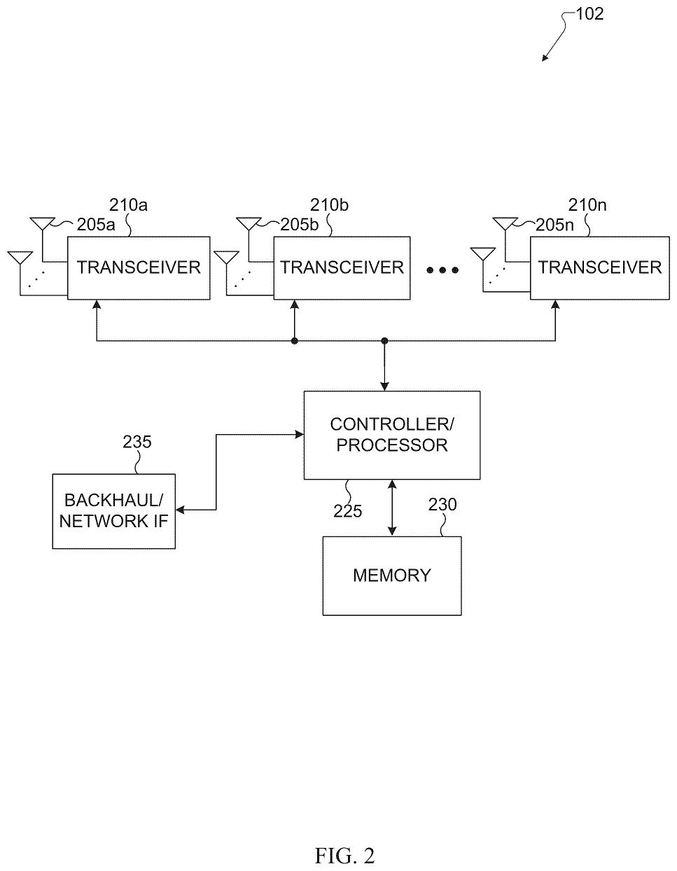

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for patterns for SSBs. Any of a wide variety of other functions could be supported in the gNB 102 by the controller/processor 225.

The controller/processor 225 is also capable of executing programs and other processes resident in the memory 230, such as processes related to supporting patterns for SSBs. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

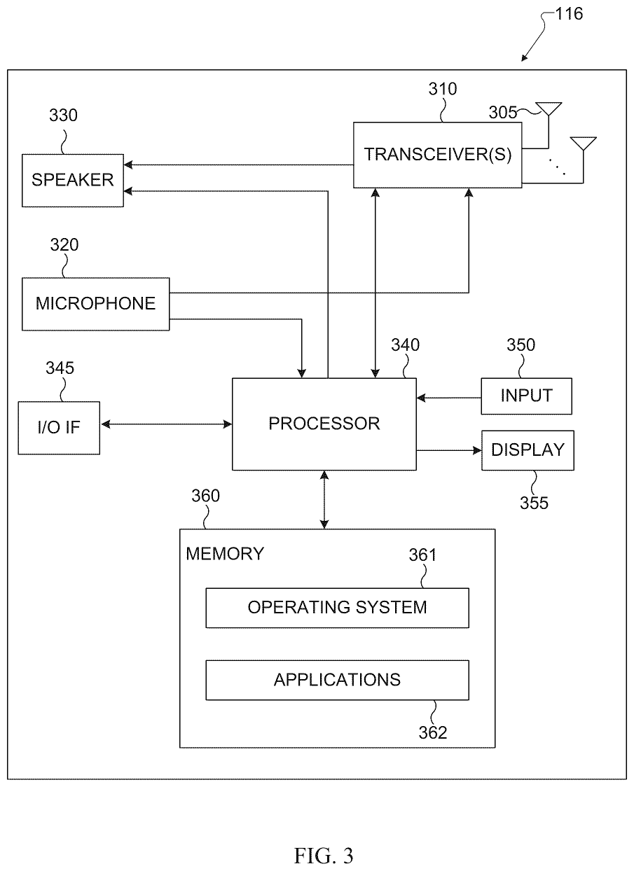

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for identifying and using patterns for SSBs as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

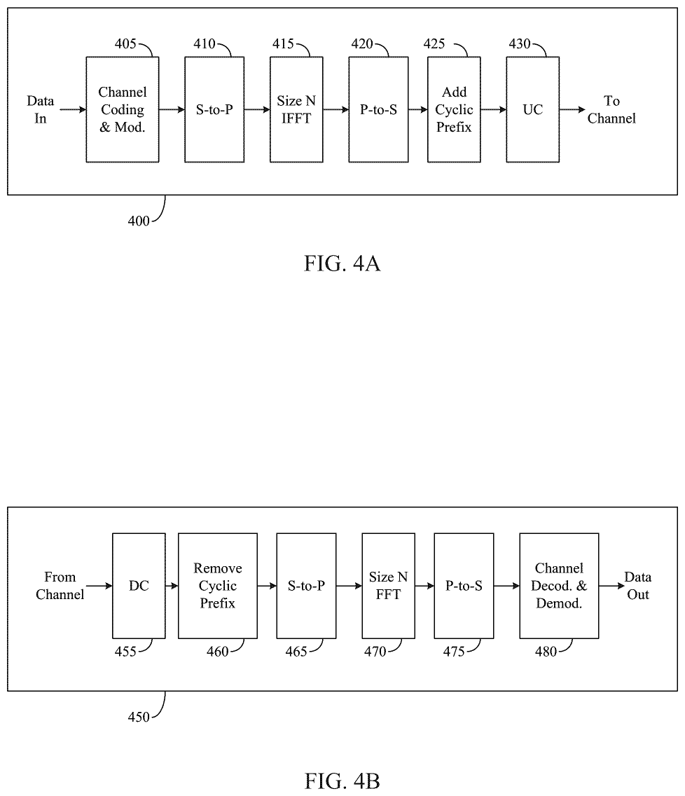

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for patterns for SSBs as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

The present disclosure covers several components which can be used in conjunction or in combination with one another, or can operate as standalone schemes.

In typical NR, for a secondary cell (SCell) implemented with periodic synchronization signal/physical broadcast channel (SS/PBCH) block transmission, a UE (e.g., the UE 116) can be provided with a configuration for radio resource management (RRM) measurement based on the periodic SS/PBCH block, wherein the configuration can be provided by a RRC parameter. After the RRM measurement, the gNB (e.g., the BS 102) can provide a configuration of the SCell, e.g., by another RRC parameter. The UE can be further provided with a MAC CE indicating an activation of the SCell, and by using the periodic SS/PBCH blocks on the SCell, or tracking reference signal (TRS) if configured, or the SS/PBCH blocks on the primary cell (PCell) when the SCell is without periodic SS/PBCH block transmission, the UE can get synchronized with the SCell and get ready to transmit or receive on the SCell. After activation of the SCell, if the SCell gets loss of synchronization, the UE can use the periodic SS/PBCH block for resynchronization. Since SS/PBCH block is transmitted on the SCell periodically, the power consumption for SS/PBCH block can be significantly large. Embodiments of the present disclosure recognizes that there is a need to reduce the power consumption. On-demand SSB can be supported on the SCell.

To further reduce the power of on-demand SSB on a SCell, the structure of on-demand SSB can be simplified from typical SSB, and the pattern of the SSB (e.g. pattern in the time domain) can also be modified accordingly. For a further step, the structure of the on-demand SSB and/or the pattern of the SSB can be flexible and configurable. The embodiments and examples of this disclosure, although motivated by on-demand SSB on a SCell, can be applicable to SS/PBCH block with and/or without a periodic transmission manner, and can be applicable to SS/PBCH block in a PCell, SCell, of primary secondary cell (PSCell).

This disclosure focuses on a pattern of SS/PBCH block as on-demand SSB. More precisely, the following aspects are included in the disclosure:
New SSB pattern for on-demand SSB
   Using 1 slot as design unit
   Using 2 slots as design unit
   Using 4 slots as design unit
Extending the number of SSB in the SSB pattern
SSB validation for on-demand SSB
Configurable SSB pattern

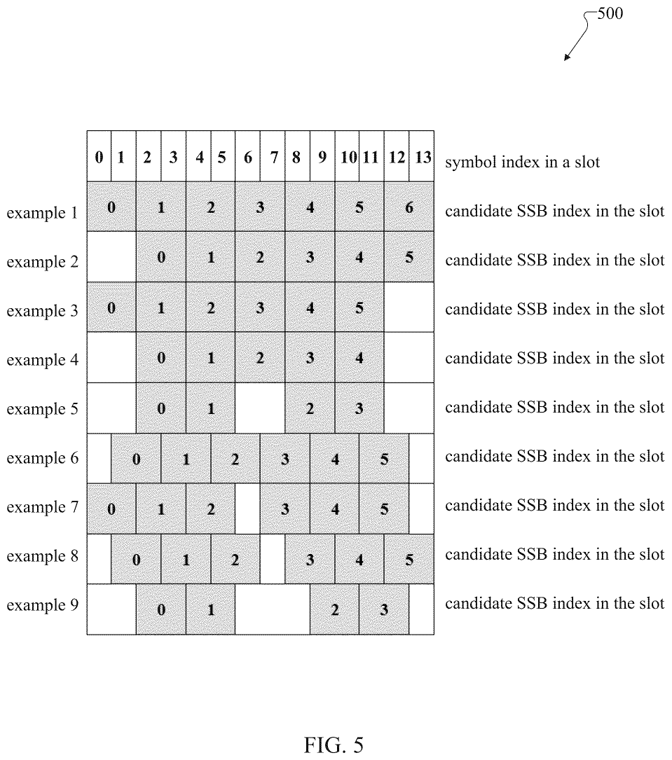

FIG. 5 illustrates a diagram of example on-demand SSB patterns 500 according to embodiments of the present disclosure. For example, on-demand SSB patterns 500 can be utilized by any of the UEs 111-116 of FIG. 1. This example is for illustration only and other embodiments can be used without departing from the scope of the present disclosure.

In one embodiment, the first symbol indexes for candidate SS/PBCH blocks (SSBs) can be determined as S+14·n, wherein S is the set of symbol indexes as the first symbol indexes for candidate SSBs within a slot. The pattern of the symbol indexes for the candidate SSBs is denoted as one example SSB pattern in this embodiment, and e.g., the SSB pattern can be applicable at least for on-demand SSB.

Examples for this embodiment are shown in FIG. 5, wherein a number of symbols for a SSB is 2. For one sub-example, the 2 symbols are mapped for primary synchronization signal (PSS) and second synchronization signal (SSS). For another sub-example, the 2 symbols are mapped for PSS frequency division multiplexed (FDMed) with PBCH, and SSS FDMed PBCH.

In a first example (Example 1 in FIG. 5), the set S={0, 2, 4, 6, 8, 10, 12}, and a number of candidate SSBs in a slot is 7.

In a second example (Example 2 in FIG. 5), the set S={2, 4, 6, 8, 10, 12}, and a number of candidate SSBs in a slot is 6.

In a third example (Example 3 in FIG. 5), the set S={0, 2, 4, 6, 8, 10}, and a number of candidate SSBs in a slot is 6.

In a forth example (Example 4 in FIG. 5), the set S={2, 4, 6, 8, 10}, and a number of candidate SSBs in a slot is 5.

In a fifth example (Example 5 in FIG. 5), the set S={2, 4, 8, 10}, and a number of candidate SSBs in a slot is 4.

In a sixth example (Example 6 in FIG. 5), the set S={1, 3, 5, 7, 9, 11}, and a number of candidate SSBs in a slot is 6.

In a seventh example (Example 7 in FIG. 5), the set S={0, 2, 4, 7, 9, 11}, and a number of candidate SSBs in a slot is 6.

In an eighth example (Example 8 in FIG. 5), the set S={1, 3, 5, 8, 10, 12}, and a number of candidate SSBs in a slot is 6.

In a ninth example (Example 9 in FIG. 5), the set S={2, 4, 9, 11}, and a number of candidate SSBs in a slot is 4.

For one further evaluation of the examples of this embodiment, the SSB pattern can be applicable for at least one subcarrier spacing (SCS) of the SSB.
For one instance, the SSB pattern can be applicable for a SCS of the SSB as 15 kHz.
For another instance, the SSB pattern can be applicable for a SCS of the SSB as 30 KHz.
For yet another instance, the SSB pattern can be applicable for a SCS of the SSB as 60 kHz.
For yet another instance, the SSB pattern can be applicable for a SCS of the SSB as 120 kHz.
For yet another instance, the SSB pattern can be applicable for a SCS of the SSB as 240 kHz.
For yet another instance, the SSB pattern can be applicable for a SCS of the SSB as 480 kHz.
For yet another instance, the SSB pattern can be applicable for a SCS of the SSB as 960 kHz.

For another further evaluation of the examples of this embodiment, the SSB pattern can be applicable for at least one frequency range.
For one instance, the SSB pattern can be applicable for FR1.
For another instance, the SSB pattern can be applicable for FR2-1.
For yet another instance, the SSB pattern can be applicable for FR2-2.

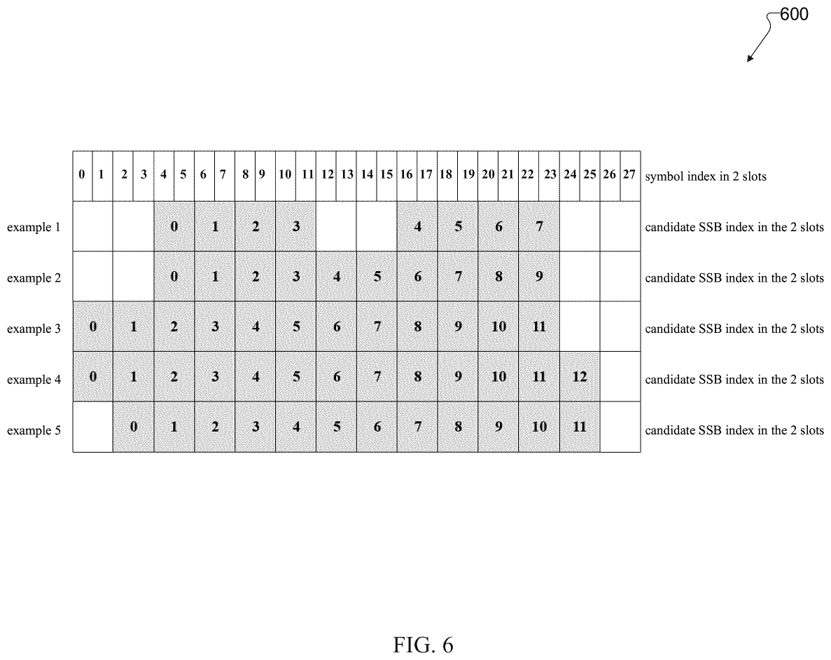

FIG. 6 illustrates a diagram of example on-demand SSB patterns 600 according to embodiments of the present disclosure. For example, on-demand SSB patterns 600 can be utilized by any of the UEs 111-116 of FIG. 1, such as the UE 111. This example is for illustration only and other embodiments can be used without departing from the scope of the present disclosure.

In one embodiment, the first symbol indexes for candidate SS/PBCH blocks (SSBs) can be determined as S+28·n, wherein S is the set of symbol indexes as the first symbol indexes for candidate SSBs within two consecutive slots. The pattern of the symbol indexes for the candidate SSBs is denoted as SSB pattern in this embodiment, and e.g., the SSB pattern can be applicable at least for on-demand SSB.

Examples for this embodiment are shown in FIG. 6, wherein a number of symbols for a SSB is 2. For one sub-example, the 2 symbols are mapped for primary synchronization signal (PSS) and second synchronization signal (SSS). For another sub-example, the 2 symbols are mapped for PSS frequency division multiplexed (FDMed) with PBCH, and SSS FDMed PBCH.

In a first example (Example 1 in FIG. 6), the set S={4, 6, 8, 10, 16, 18, 20, 22}, and a number of candidate SSBs in two consecutive slots is 8.

In a second example (Example 2 in FIG. 6), the set S={4, 6, 8, 10, 12, 14, 16, 18, 20, 22}, and a number of candidate SSBs in two consecutive slots is 10.

In a third example (Example 3 in FIG. 6), the set S={0, 2, 4, 6, 8, 10, 12, 14, 16, 18, 20, 22}, and a number of candidate SSBs in two consecutive slots is 12.

In a forth example (Example 4 in FIG. 6), the set S={0, 2, 4, 6, 8, 10, 12, 14, 16, 18, 20, 22, 24}, and a number of candidate SSBs in two consecutive slots is 13.

In a fifth example (Example 5 in FIG. 6), the set S={2, 4, 6, 8, 10, 12, 14, 16, 18, 20, 22, 24}, and a number of candidate SSBs in two consecutive slots is 12.

For one further evaluation of the examples of this embodiment, the SSB pattern can be applicable for at least one SCS of the SSB.
For one instance, the SSB pattern can be applicable for a SCS of the SSB as 15 kHz.
For another instance, the SSB pattern can be applicable for a SCS of the SSB as 30 kHz.
For yet another instance, the SSB pattern can be applicable for a SCS of the SSB as 60 kHz.
For yet another instance, the SSB pattern can be applicable for a SCS of the SSB as 120 kHz.
For yet another instance, the SSB pattern can be applicable for a SCS of the SSB as 240 kHz.
For yet another instance, the SSB pattern can be applicable for a SCS of the SSB as 480 kHz.
For yet another instance, the SSB pattern can be applicable for a SCS of the SSB as 960 kHz.

For another further evaluation of the examples of this embodiment, the SSB pattern can be applicable for at least one frequency range.
For one instance, the SSB pattern can be applicable for FR1.
For another instance, the SSB pattern can be applicable for FR2-1.
For yet another instance, the SSB pattern can be applicable for FR2-2.

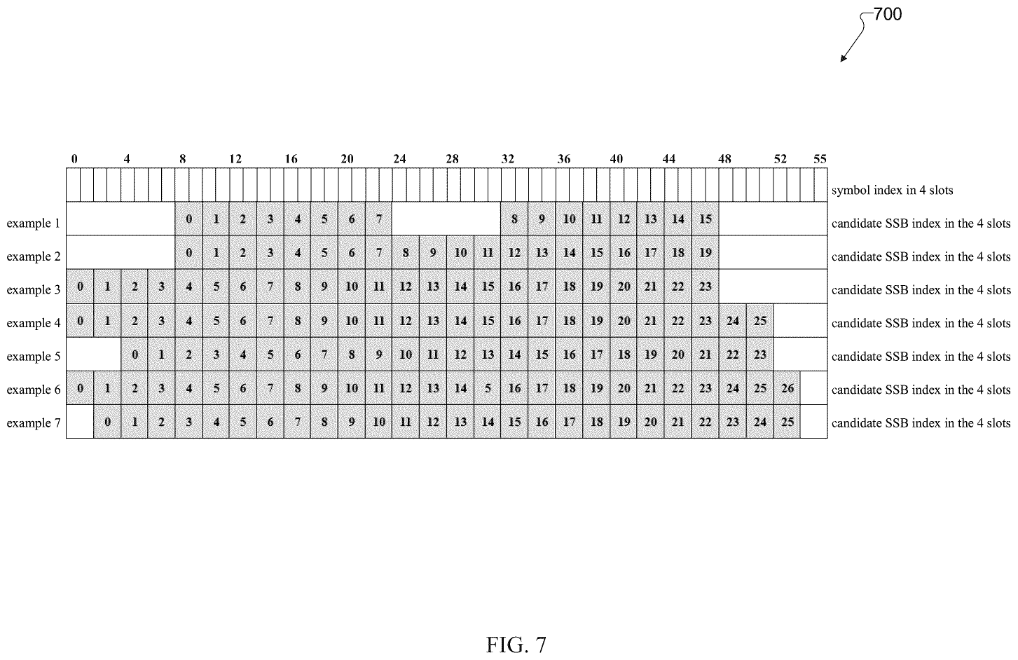

FIG. 7 illustrates a diagram of example on-demand SSB patterns 700 according to embodiments of the present disclosure. For example, on-demand SSB patterns 700 can be utilized by any of the UEs 111-116 of FIG. 1, such as the UE 116. This example is for illustration only and other embodiments can be used without departing from the scope of the present disclosure.

In one embodiment, the first symbol indexes for candidate SS/PBCH blocks (SSBs) can be determined as S+56·n, wherein S is the set of symbol indexes as the first symbol indexes for candidate SSBs within two consecutive slots. The pattern of the symbol indexes for the candidate SSBs is denoted as SSB pattern in this embodiment, and e.g., the SSB pattern can be applicable at least for on-demand SSB.

Examples for this embodiment are shown in FIG. 7, wherein a number of symbols for a SSB is 2. For one sub-example, the 2 symbols are mapped for primary synchronization signal (PSS) and second synchronization signal (SSS). For another sub-example, the 2 symbols are mapped for PSS frequency division multiplexed (FDMed) with PBCH, and SSS FDMed PBCH.

In a first example (Example 1 in FIG. 7), the set S={8, 10, 12, 14, 16, 18, 20, 22, 32, 34, 36, 38, 40, 42, 44, 46}, and a number of candidate SSBs in two consecutive slots is 16.

In a second example (Example 2 in FIG. 7), the set S={8, 10, 12, 14, 16, 18, 20, 22, 24, 26, 28, 30, 32, 34, 36, 38, 40, 42, 44, 46}, and a number of candidate SSBs in two consecutive slots is 20.

In a third example (Example 3 in FIG. 7), the set S={0, 2, 4, 6, 8, 10, 12, 14, 16, 18, 20, 22, 24, 26, 28, 30, 32, 34, 36, 38, 40, 42, 44, 46}, and a number of candidate SSBs in two consecutive slots is 24.

In a forth example (Example 4 in FIG. 7), the set S={0, 2, 4, 6, 8, 10, 12, 14, 16, 18, 20, 22, 24, 26, 28, 30, 32, 34, 36, 38, 40, 42, 44, 46, 48, 50}, and a number of candidate SSBs in two consecutive slots is 26.

In a fifth example (Example 5 in FIG. 7), the set S={4, 6, 8, 10, 12, 14, 16, 18, 20, 22, 24, 26, 28, 30, 32, 34, 36, 38, 40, 42, 44, 46, 48, 50}, and a number of candidate SSBs in two consecutive slots is 24.

In a sixth example (Example 6 in FIG. 7), the set S={0, 2, 4, 6, 8, 10, 12, 14, 16, 18, 20, 22, 24, 26, 28, 30, 32, 34, 36, 38, 40, 42, 44, 46, 48, 50, 52}, and a number of candidate SSBs in two consecutive slots is 27.

In a seventh example (Example 7 in FIG. 7), the set S={2, 4, 6, 8, 10, 12, 14, 16, 18, 20, 22, 24, 26, 28, 30, 32, 34, 36, 38, 40, 42, 44, 46, 48, 50, 52}, and a number of candidate SSBs in two consecutive slots is 26.

For one further evaluation of the examples of this embodiment, the SSB pattern can be applicable for at least one SCS of the SSB.
For one instance, the SSB pattern can be applicable for a SCS of the SSB as 15 kHz.
For another instance, the SSB pattern can be applicable for a SCS of the SSB as 30 kHz.
For yet another instance, the SSB pattern can be applicable for a SCS of the SSB as 60 kHz.
For yet another instance, the SSB pattern can be applicable for a SCS of the SSB as 120 kHz.
For yet another instance, the SSB pattern can be applicable for a SCS of the SSB as 240 kHz.
For yet another instance, the SSB pattern can be applicable for a SCS of the SSB as 480 kHz.
For yet another instance, the SSB pattern can be applicable for a SCS of the SSB as 960 kHz.

For another further evaluation of the examples of this embodiment, the SSB pattern can be applicable for at least one frequency range.
For one instance, the SSB pattern can be applicable for FR1.
For another instance, the SSB pattern can be applicable for FR2-1.
For yet another instance, the SSB pattern can be applicable for FR2-2.

In one embodiment, the number of candidate SS/PBCH blocks in a burst can be extended. For example, the extension of the number of candidate SS/PBCH blocks in a burst can be applicable at least for on-demand SSB. For another example, the extension of the number of candidate SS/PBCH blocks in a burst can be applicable to periodic SSB.

For one example, the number of candidate SS/PBCH blocks can be extended such that the candidate SS/PBCH blocks are located across half frame boundary (e.g., the candidate SS/PBCH block burst is longer than a half frame).

For another example, the number of candidate SS/PBCH blocks can be extended such that the candidate SS/PBCH blocks are located within a half frame (e.g., the candidate SS/PBCH block burst is no longer than a half frame).

For yet another example, the number of candidate SS/PBCH blocks can be extended such that the candidate SS/PBCH blocks are located in slots within a half frame (e.g., the candidate SS/PBCH block burst equals to a half frame).

For one example, the starting symbol in a SSB pattern can be same as the one in Rel-15/16/17/18 or NR, and only the value of n in the SSB pattern is extended comparing to Rel-15/16/17/18 or NR.

For another example, the starting symbol in a SSB pattern can be according to an example as in this disclosure, and the value of n in the SSB pattern is determined such that the maximum number of candidate SSB is same as L̅ₘₐₓ.

For yet another example, the starting symbol in a SSB pattern can be according to an example as in this disclosure, and the value of n in the SSB pattern is extended such that the maximum number of candidate SSB larger than L̅ₘₐₓ as in Rel-15/16/17/18 or NR.

For one example, a UE expects a number Lₘₐₓ of SSB are transmitted out of the L̅ₘₐₓ candidate SSB occasions.

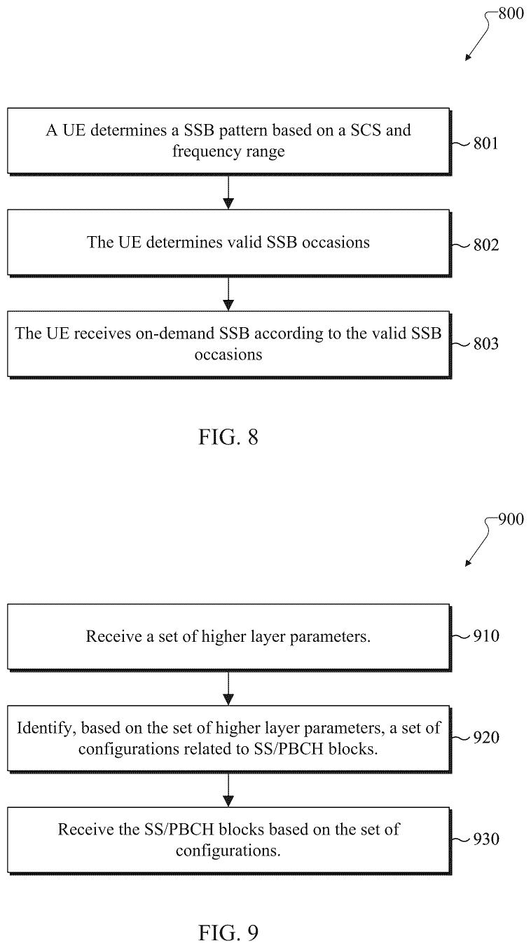

FIG. 8 illustrates a flowchart of an example UE procedure 800 for receiving an on-demand SSB according to embodiments of the present disclosure. For example, procedure 800 can be performed by the UE 116 of FIG. 3. This example is for illustration only and other embodiments can be used without departing from the scope of the present disclosure.

The procedure begins in 801, a UE determines a SSB pattern based on a SCS and frequency range. In 802, the UE determines valid SSB occasions. In 803, the UE receives on-demand SSB according to the valid SSB occasions.

In one embodiment, part or each of the candidate SSB occasions can be determined as valid for on-demand SSB transmission, according to at least one example of this embodiment.

For one example, a candidate SSB for on-demand SSB transmission overlapping or partially overlapping with a periodic SSB is regarded as not valid or expected to be not transmitted.

For another example, if a candidate SSB for on-demand SSB transmission overlaps or partially overlaps with a periodic SSB, the periodic SSB is expected to be not transmitted.

For yet another example, the UE expects a candidate SSB for on-demand SSB transmission do not overlap with a periodic SSB.

For one example, a candidate SSB for on-demand SSB transmission overlapping or partially overlapping with a RE for TRS is not valid. For instance, the TRS can be configured for the SCell activation.

For another example, if a candidate SSB for on-demand SSB transmission overlaps or partially overlaps with a RE for TRS, the TRS is expected to be not transmitted. For instance, the TRS can be configured for the SCell activation.

For yet another example, if a candidate SSB for on-demand SSB transmission overlaps or partially overlaps with a RE for TRS, the TRS is expected to be not transmitted on the REs that overlap or partially overlap with the candidate SSB. For instance, the TRS can be configured for the SCell activation.

For yet another example, the UE expects that REs for a candidate SSB for on-demand SSB transmission do not overlap with REs for TRS. For instance, the TRS can be configured for the SCell activation.

For one example, a candidate SSB for on-demand SSB transmission overlapping or partially overlapping with a CORESET is not valid. For one instance, the CORESET can be at least for Type0 physical downlink control channel Type0-PDCCH monitoring.

For another example, a candidate SSB for on-demand SSB transmission overlapping or partially overlapping with a physical downlink control channel (PDCCH) in a CORESET is not valid. For one instance, the CORESET can be at least for Type0-PDCCH monitoring.

For yet another example, if a candidate SSB for on-demand SSB transmission overlaps or partially overlaps with a CORESET, the PDCCH in the CORESET is expected to be not transmitted. For one instance, the CORESET can be at least for Type0-PDCCH monitoring.

For yet another example, if a candidate SSB for on-demand SSB transmission overlaps or partially overlaps with a RE for a CORESET, the PDCCH in the CORESET is expected to be not transmitted on the REs that overlap or partially overlap with the candidate SSB. For one instance, the CORESET can be at least for Type0-PDCCH monitoring.

For yet another example, the UE expects that REs for a candidate SSB for on-demand SSB transmission do not overlap with REs for a CORESET. For one instance, the CORESET can be at least for Type0-PDCCH monitoring.

For one example, a candidate SSB for on-demand SSB transmission overlapping or partially overlapping with a RE for an uplink transmission is not valid. For instance, the uplink transmission can be a physical random access channel (PRACH), or a physical uplink control channel (PUCCH), or a physical uplink shared channel (PUSCH), or a SRS.

For another example, if a candidate SSB for on-demand SSB transmission overlaps or partially overlaps with a RE for an uplink transmission, the uplink transmission is expected to be not transmitted. For instance, the uplink transmission can be a PRACH, or a PUCCH, or a PUSCH, or a sounding reference signal (SRS).

For yet another example, if a candidate SSB for on-demand SSB transmission overlaps or partially overlaps with a RE for an uplink transmission, the uplink transmission is expected to be not transmitted on the REs that overlap or partially overlap with the candidate SSB. For instance, the uplink transmission can be a PRACH, or a PUCCH, or a PUSCH, or a SRS.

For yet another example, the UE expects that REs for a candidate SSB for on-demand SSB transmission do not overlap with REs for an uplink transmission. For one instance, the uplink transmission can be a PRACH, or a PUCCH, or a PUSCH, or a SRS.

For one example, if a candidate SSB for on-demand SSB transmission overlaps or partially overlaps with a symbol that is indicated as uplink (e.g., by a RRC parameter indicating the slot format, and/or by a downlink control information (DCI) indicating the slot format), the candidate SSB is not valid for on-demand SSB transmission.

For another example, if a candidate SSB for on-demand SSB transmission overlaps or partially overlaps with a symbol that is not indicated as downlink (e.g., by a RRC parameter indicating the slot format, and/or by a DCI indicating the slot format), the candidate SSB is not valid for on-demand SSB transmission.

For one example, if a candidate SSB for on-demand SSB transmission overlaps or partially overlaps with a symbol that is indicated for uplink transmission (e.g., by a DCI indicating an uplink transmission), the candidate SSB is not valid for on-demand SSB transmission.

For one example, if a candidate SSB for on-demand SSB transmission overlaps or partially overlaps with a symbol that is scheduled or configured for uplink transmission (e.g., configured PUSCH), the candidate SSB is not valid for on-demand SSB transmission.

An example UE procedure for SSB pattern and validation is shown in FIG. 8.

In one embodiment, a pattern for SS/PBCH block can be configurable. For one further evaluation, multiple candidate patterns for SS/PBCH block can be pre-defined in the specification for system operation and at least one of them can be configured, e.g., by higher layer parameter. For another further evaluation, at least one of the following parameters for the pattern for SS/PBCH block can be configured.

For a first example, a (maximum) number of (candidate) SS/PBCH block in a burst.

For a second example, actually transmitted SS/PBCH block in a burst. For one further evaluation, a UE (e.g., the UE 116) can determine a number of actually transmitted SS/PBCH block in a burst based on the actually transmitted SS/PBCH block in a burst.

For a third example, at least one time domain gap between two consecutive SS/PBCH blocks in a burst. For one instance, the at least one time domain gap can be in a number of OFDM symbols. For another instance, when the at least one time domain gap is configured as 0, or the time domain gap is not configured, a default value can be expected by a UE, e.g., a default value can be 0, or a default value can be determined based on a default pattern of SS/PBCH block. For yet another instance, the time domain gap may not be unique for all the SS/PBCH blocks in the burst, and the time domain gap can be determined by the starting symbols of the candidate SS/PBCH blocks in a burst.

For a fourth example, a SS/PBCH block structure. For one instance, the SS/PBCH block structure includes a number of OFDM symbols of the SS/PBCH block. For another instance, the SS/PBCH block structure includes a number of subcarriers or resource blocks as a bandwidth of the SS/PBCH block. For yet another instance, the SS/PBCH block structure includes which signal and/or channel is included in the SS/PBCH block structure, and/or how the signal and/or channel are multiplexed, wherein, e.g., the signal and/or channel can include primary synchronization signal (PSS), or secondary synchronization signal (SSS), or tertiary synchronization signal (TSS), or physical broadcast channel (PBCH), or additional PBCH, or demodulation reference signal (DM-RS) of PBCH, and/or the multiplexing method can be at least one or combination of time division multiplexing (TDM), frequency domain multiplexing (FDM), or interleaved frequency domain multiplexing (IFDM). For yet another instance, multiple candidate SS/PBCH block structures can be pre-defined in the specification for system operation and at least one of them can be configured, e.g., by higher layer parameter.

For one example, at least one of the examples of this embodiments can formulate a pattern for the SS/PBCH block, wherein the pattern can be also associated with other time domain parameters as following:
For one instance, a time location of SS/PBCH block burst. For one instance, the time location can be a half frame (within a periodicity) for SS/PBCH block burst, and/or slot(s) (within a periodicity) for SS/PBCH block burst. For another instance, the time location can be determined based on a reference timing and a time offset to the reference timing.
For another instance, a periodicity of the SS/PBCH block (or SS/PBCH block burst), which could also be referred to as a time domain interval between two neighboring SS/PBCH block bursts. For one instance, the candidate values of the periodicity to be configured can be {2.5, 5, 10, 20, 40, 80, 160, 320, 640, 1280} ms or its subset. For another instance, some additional candidate values of the periodicity to be configured can be {1, 2, 3, 4} ms or its subset. For yet another instance, some candidate values can be applicable for any cell, e.g., commonly configurable for any cell. For yet another instance, some candidate values can be applicable for SCell only, e.g., candidate values smaller than 5 ms, and/or candidate values larger than 160 ms.
For yet another instance, a number of (transmitted) SS/PBCH block burst(s). For one instance, this example can be applicable when the SS/PBCH block transmission is not periodic, and/or activated by a trigger from the BS.

For one example, at least one of the examples of this embodiments can formulate a pattern for the SS/PBCH block, wherein the pattern can be also associated with parameters other than time domain parameters as following:
For one instance, a subcarrier spacing of the SS/PBCH block.
For another instance, a frequency location of the SS/PBCH block.
For yet another instance, a physical cell ID associated with the SS/PBCH block.
For yet another instance, a transmission power of the SS/PBCH block.

For one example, at least one pattern of the SS/PBCH block or at least one parameter of or associated with the pattern of the SS/PBCH block can be pre-defined in the specification, and a UE can be provided with a configuration on each or a subset of them, e.g., by system information and/or dedicated RRC parameter.

For another example, at least one pattern of the SS/PBCH block or at least one parameter of or associated with the pattern of the SS/PBCH block can be provided to the UE by system information and/or dedicated RRC parameter.

For yet another example, at least one pattern of the SS/PBCH block or at least one parameter of or associated with the pattern of the SS/PBCH block can be configured to a UE (e.g., as a set of candidates), and the UE can be provided with a MAC CE or a DCI format to activate at least one from the candidates.

For yet another example, at least one pattern of the SS/PBCH block or at least one parameter of or associated with the pattern of the SS/PBCH block can be reported by a UE as a UE capability.

For yet another example, at least one pattern of the SS/PBCH block or at least one parameter of or associated with the pattern of the SS/PBCH block can be provided by a UE using UE assistant information, e.g., to indicate the UE's preferred pattern and/or parameter.

For one example, this embodiment can be applicable to SS/PBCH block on a SCell or PSCell. For another example, this embodiment can be applicable to SS/PBCH block on a PCell. For yet another example, this embodiment can be applicable to SS/PBCH block associated with an operation mode (e.g., an energy saving mode, or a non-energy saving mode) of a cell.

For one example, this embodiment can be applicable to SS/PBCH block located on a frequency location not corresponding to any synchronization raster entry. For another example, this embodiment can be applicable to SS/PBCH block located on a frequency location corresponding to a synchronization raster entry. For yet another example, this embodiment can be applicable to SS/PBCH block with an associated system information block (e.g., system information block 1), e.g., cell-defining SSB. For yet another example, this embodiment can be applicable to SS/PBCH block without an associated system information block (e.g., system information block 1), e.g., non-cell-defining SSB.

For one example, this embodiment can be applicable to on-demand SS/PBCH block. For another example, this embodiment can be applicable to periodic SS/PBCH block.

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method 900 begins with the UE receiving a set of higher layer parameters (910). The UE then identifies, based on the set of higher layer parameters, a set of configurations related to SS/PBCH blocks (920). For example, in 920, the set of configurations include at least one of a time domain interval between two consecutive SS/PBCH blocks in a burst or an indication of a structure of the SS/PBCH blocks in the burst. In various embodiments, the set of configurations further include at least one of an indication of actually transmitted SS/PBCH blocks in the burst, time domain locations of bursts of the SS/PBCH blocks, and a periodicity for the bursts. In various embodiments, the set of configurations further include at least one of a frequency domain location of the SS/PBCH blocks, a subcarrier spacing of the SS/PBCH blocks, a physical cell identity associated with the SS/PBCH blocks, and a transmission power of the SS/PBCH blocks. In various embodiments, the frequency domain location does not correspond to a synchronization raster entry.

In various embodiments, the time domain interval is a number of OFDM symbols between two consecutive SS/PBCH blocks in the burst. In various embodiments, the structure of the SS/PBCH blocks includes at least one of a number of OFDM symbols in a SS/PBCH block of the SS/PBCH blocks, a bandwidth of the SS/PBCH block, and components of signals or channels included in the SS/PBCH block.

The UE then receives the SS/PBCH blocks based on the set of configurations (930). In various embodiments, the SS/PBCH blocks are associated with a SCell.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of higher layer parameters; and
a processor operably coupled to the transceiver, the processor configured to identify, based on the set of higher layer parameters, a set of configurations related to synchronization signals and physical broadcast channel (SS/PBCH) blocks, wherein the set of configurations include:
a time domain interval between two consecutive SS/PBCH blocks in a burst; or
an indication of a structure of the SS/PBCH blocks in the burst;
wherein the transceiver is further configured to receive the SS/PBCH blocks based on the set of configurations.

2. The UE of claim 1, wherein the set of configurations further include:
an indication of actually transmitted SS/PBCH blocks in the burst;
time domain locations of bursts of the SS/PBCH blocks; and
a periodicity for the bursts.

3. The UE of claim 1, wherein the set of configurations further include:
a frequency domain location of the SS/PBCH blocks;
a subcarrier spacing of the SS/PBCH blocks;
a physical cell identity associated with the SS/PBCH blocks; and
a transmission power of the SS/PBCH blocks.

4. The UE of claim 3, wherein the frequency domain location does not correspond to a synchronization raster entry.

5. The UE of claim 1, wherein the structure of the SS/PBCH blocks includes:
a number of orthogonal frequency division multiplexing (OFDM) symbols in a SS/PBCH block of the SS/PBCH blocks;
a bandwidth of the SS/PBCH block; or
components of signals or channels included in the SS/PBCH block.

6. The UE of claim 1, wherein the time domain interval is a number of orthogonal frequency division multiplexing (OFDM) symbols between two consecutive SS/PBCH blocks in the burst.

7. The UE of claim 1, wherein the SS/PBCH blocks are associated with a secondary cell (SCell).

8. A base station (BS) in a wireless communication system, the BS comprising:
a processor configured to:
determine a set of configurations related to synchronization signals and physical broadcast channel (SS/PBCH) blocks, wherein the set of configurations include:
a time domain interval between two consecutive SS/PBCH blocks in a burst; or
an indication of a structure of the SS/PBCH blocks in the burst; and
determine a set of higher layer parameters including the set of configurations; and
a transceiver operably coupled to the processor, the transceiver configured to:
transmit the set of higher layer parameters; and
transmit the SS/PBCH blocks based on the set of configurations.

9. The BS of claim 8, wherein the set of configurations further include:
an indication of actually transmitted SS/PBCH blocks in the burst;
time domain locations of bursts of the SS/PBCH blocks; and
a periodicity for the bursts.

10. The BS of claim 8, wherein the set of configurations further include:
a frequency domain location of the SS/PBCH blocks;
a subcarrier spacing of the SS/PBCH blocks;
a physical cell identity associated with the SS/PBCH blocks; and
a transmission power of the SS/PBCH blocks.

11. The BS of claim 10, wherein the frequency domain location does not correspond to a synchronization raster entry.

12. The BS of claim 8, wherein the structure of the SS/PBCH blocks includes:
a number of orthogonal frequency division multiplexing (OFDM) symbols in a SS/PBCH block of the SS/PBCH blocks;
a bandwidth of the SS/PBCH block; or
components of signals or channels included in the SS/PBCH block.

13. The BS of claim 8, wherein the time domain interval is a number of orthogonal frequency division multiplexing (OFDM) symbols between two consecutive SS/PBCH blocks in the burst.

14. The BS of claim 8, wherein the SS/PBCH blocks are associated with a secondary cell (SCell).

15. A method of a user equipment (UE) in a wireless communication system, the method comprising:
receiving a set of higher layer parameters;
identifying, based on the set of higher layer parameters, a set of configurations related to synchronization signals and physical broadcast channel (SS/PBCH) blocks, wherein the set of configurations include:
a time domain interval between two consecutive SS/PBCH blocks in a burst; or
an indication of a structure of the SS/PBCH blocks in the burst; and
receiving the SS/PBCH blocks based on the set of configurations.

16. The method of claim 15, wherein the set of configurations further include:
an indication of actually transmitted SS/PBCH blocks in the burst;
time domain locations of bursts of the SS/PBCH blocks; and
a periodicity for the bursts.

17. The method of claim 15, wherein the set of configurations further include:
a frequency domain location of the SS/PBCH blocks, wherein the frequency domain location does not correspond to a synchronization raster entry;
a subcarrier spacing of the SS/PBCH blocks;
a physical cell identity associated with the SS/PBCH blocks; and
a transmission power of the SS/PBCH blocks.

18. The method of claim 15, wherein the structure of the SS/PBCH blocks includes:
a number of orthogonal frequency division multiplexing (OFDM) symbols in a SS/PBCH block of the SS/PBCH blocks;
a bandwidth of the SS/PBCH block; or
components of signals or channels included in the SS/PBCH block.

19. The method of claim 15, wherein the time domain interval is a number of orthogonal frequency division multiplexing (OFDM) symbols between two consecutive SS/PBCH blocks in the burst.

20. The method of claim 15, wherein the SS/PBCH blocks are associated with a secondary cell (SCell).
